(19) United States
(12) Patent Application Publication
(10) Pub. No.: US 2010/0055402 A1
(43) Pub. Date: Mar. 4, 2010

(54) FILM, AND PROCESS FOR PRODUCING THE SAME

(75) Inventors: Yuuji Yamashita, Ibaraki-shi (JP); Kenji Shimizu, Ibaraki-shi (JP); Michihiro Omae, Ibaraki-shi (JP); Ryuichi Kira, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/440,777

(22) PCT Filed: Aug. 1, 2008
(86) PCT No.: PCT/JP2008/063834

§ 371 Date: Mar. 11, 2009

(30) Foreign Application Priority Data
Aug. 10, 2007 (JP) 2007-209962

(51) Int. Cl. B32B 3/02; B29C 59/16

(52) U.S. Cl. 428/156; 264/400

(57) ABSTRACT

Disclosed is a film which is knurling-processed without the facture of the film. Also disclosed is a method for producing the film. The film comprises a polymer resin film, in which a knurling processing is applied on both end parts in the width-wise direction on at least one surface of the film by irradiating the film with a laser beam.

### TECHNICAL FIELD

The present invention relates to a film wherein both end regions in the width direction are subjected to knurling, and a process for producing the same.

### BACKGROUND ART

Plastic films each used for a transparent protective film of a polarizing plate, or the like are each produced by, for example, a solution film-forming process, and the film is then rewound into a roll form, and stored and transported.

However, the film has a problem that when the film is rewound, there are generated winding shift, winding looseness, blocking, an appearance poorness that results from thickness unevenness and is called a gage band (or may be called a piston ring), and others. In order to solve this problem, end regions of the film are conventionally subjected to knurling, which is a work for forming minute unevennesses and may be referred to as embossing or roulette work, or referred to by some other name.

The knurling is, for example, a method of sandwiching a film between a pair of embossing rolls each having a surface having unevennesses and then pushing/pressing the film therebetween (Patent Documents 1 and 2 described below, and others). However, the method using the embossing rolls has a problem that in a case where the thickness of the film is small (for example, a thickness of 20 to 55 μm), the film is broken when subjected to knurling. In a case where the film is bent after the knurling, there is caused a problem that the region subjected to the knurling is easily broken.

Patent Document 1: JP-A-2007-91784

Patent Document 2: JP-A-2002-211803

### DISCLOSURE OF THE INVENTION

### Problems to be Solved by the Invention

In light of the above-mentioned problems, the invention has been made, and an object thereof is to provide a film subjected to knurling without being broken, and a process for producing the film.

### Means for Solving the Problems

In order to solve the problems in the conventional art, the inventors have investigated films, and producing processes thereof. As a result, the inventors have found out that the object can be attained by adopting a structure described below, so as to complete the present invention.

That is, the present invention relates to a polymeric resin film, wherein about at least one of its surfaces, both end regions thereof in the width direction of the film are subjected to knurling by radiation of a laser.

According to the structure, in the knurling according to the invention, a laser is radiated onto a surface of a polymeric resin film, thereby thermal-melting or ablation to the surface locally. In this way, knurling is conducted. As a result, even about a film small in thickness, the film can be prevented from being broken when subjected to the knurling. Furthermore, even when the film is bent, the regions subjected to the knurling are not broken. This appears to result from the following matter: it never happens that an unnecessary pressure is applied to the polymeric resin film as, for example, in a case where the film is sandwiched between a pair of embossing rolls and subjected to knurling; thus, no residual stress remains in the polymeric resin film.

In a case where a polymeric resin film is subjected to knurling by pushing a heated embossing roll against the film, there is caused a problem that the surface of the polymeric resin film is shaved with the embossing rolls or the film is contaminated in the vicinity of the region subjected to the knurling. However, in the invention, knurling is attained by the radiation of a laser; therefore, the surface of the polymeric resin film can be restrained from being shaved or contaminated.

In the above structure, when the average thickness of the region not subjected to the knurling is represented by T (μm) and the average thickness of both the end regions subjected to the knurling is preferably represented by Tn (μm),

T (μm) ranges from 20 to 70 μm and Tn−T ranges from 3 to 30 μm.

Setting the knurling height (Tn−T) of both the end regions subjected to the knurling into the range of 3 to 30 μm, it makes possible to restrain sufficiently the generation of winding shift and winding looseness when the film is wound, blocking, an appearance poorness that results from thickness unevenness and is called a gage band (or may be called a piston ring), and others, and further restrain the film from being broken at both the end regions.

In the above structure, the polymeric resin film preferably has a tensile strength of 100 MPa or less and a tensile elongation of 80% or less. Even in a case where the polymeric resin film has the physical properties, the film provided can be a film subjected to knurling without being broken.

In the above structure, the polymeric resin film preferably is an optical film.

In the above structure, the optical film is preferably a transparent protective film.

In the above structure, the transparent protective film is preferably a norbornene based film or an acrylic film.

The present invention relates to a film as recited is set on at least one of surfaces of a polarizer.

The present invention relates to a process for producing a film, wherein about at least one of surfaces of a polymeric resin film, a laser is radiated onto both end regions thereof in the width direction of the film under predetermined conditions, thereby subjecting both the end regions to knurling.

According to the process, in the invention, a laser is radiated onto a surface of a polymeric resin film, thereby thermal-melting or ablation to the surface locally; therefore, both end regions thereof can be subjected to knurling without being broken. Moreover, even when the film is bent after the radiation of the laser, the film can be restrained from being broken.

Furthermore, according to the process, the knurling is conducted by effect of not heated embossing rolls but the radiation of a laser; therefore, the knurling can be attained without shaving nor contaminating the polymeric resin film.

Additionally, only by varying the position onto which the laser is radiated appropriately, the pattern or density of unevennesses can be changed. Thus, design change according to the knurling can be more easily made than according to conventional work using embossing rolls.

In the above method, the radiation of the laser is preferably performed so as not to penetrate the film in such a manner that the power thereof is set into the range of 1 to 20 W. When the power of the laser radiation is set to 1 W or more, the radiated amount of the laser is prevented from being short so that the knurling can be sufficiently subjected to the surface of the polymeric resin film. On the other hand, when the power is set to 20 W or less, the generation of through holes can be prevented in the polymeric resin film and further thermal effect on the vicinity of the radiated region can be restrained to prevent the following: the fine work width is made larger and some other phenomenon is caused so that a desired fine pattern cannot be obtained.

### EFFECTS OF THE INVENTION

In the invention, a laser is radiated onto a polymeric resin film, thereby thermal-melting or ablation locally to the film to conduct knurling. For this reason, the film can be prevented from being broken when subjected to the knurling and when bent after the work. According to this, winding shift and other problems generated when the film is wound can be further restrained. Thus, the production yield of polarizing plates or laminated optical films each having such a polarizing plate can be made still better.

### BRIEF DESCRIPTION OF THE DRAWINGS

FIG. 1 are each a schematic view which schematically illustrates a film according to the present embodiment, and FIG. 1(a) illustrates a situation that one of surfaces of a film is subjected to knurling and FIG. 1(b) illustrates a situation that both surfaces of a film are subjected to knurling.

FIG. 2 are partial plan views which schematically illustrate one of the films, and FIG. 2(a) illustrates a situation that a knurling region is located at a position apart from an end of the film, which is made of a polymeric resin, and FIG. 2(b) illustrates a situation that a knurling region is made consistent with an end of the polymeric resin film.

### REFERENCE NUMBERS

1 a polymeric resin film
10, 11 films
12 an non-worked region
13 knurling region(s)
14 concaves

### BEST MODE FOR CARRYING OUT THE INVENTION

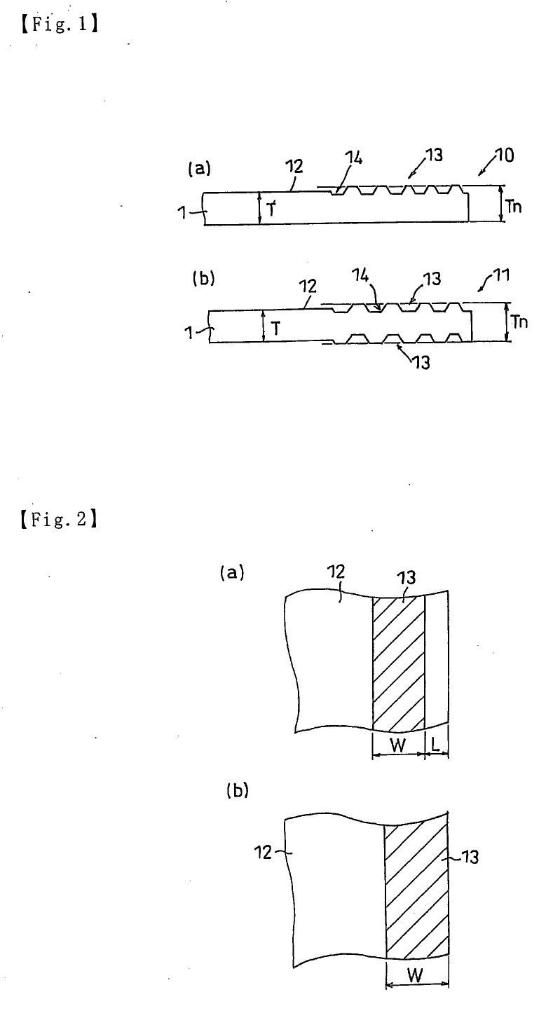

With reference to the drawings, an embodiment of the invention will be described hereinafter. FIG. 1 are each a schematic view which schematically illustrates a film according to the present embodiment, and FIG. 1(a) illustrates a situation that one of surfaces of a film is subjected to knurling and FIG. 1(b) illustrates a situation that both surfaces of a film are subjected to knurling.

As illustrated in FIG. 1(a), a film 10, which is the film according to the present embodiment, has a structure wherein one of surfaces of a polymeric resin film 1 is subjected to knurling. As illustrated in FIG. 1(b), the film of the present embodiment may a film 11 having a structure wherein both surfaces of a polymeric resin film 1 are subjected to knurling.

In the invention, the film can be subjected to knurling without being broken even when the average thickness T (μm) of a non-worked region 12, which is not subjected to any knurling, is from 20 to 70 μm. When the thickness of the non-worked region 12 is less than 20 μm, a film wherein the surface smoothness of this region is high is not easily formed when the film is desired to be obtained. Additionally, the mechanical strength of the film lowers, so that the film is easily broken when subjected to knurling or after the knurling.

When the average thickness of knurling regions 13 is represented by Tn (μm), the knurling height (Tn−T (μm)) ranges preferably from 3 to 30 μm, more preferably from 3 to 15 μm, even more preferably from 3 to 7 μm. When (Tn−T (μm)) is less than 3 μm, declined is the effect of restraining the generation of winding shift, winding looseness when the film is wound, an appearance poorness that results from thickness unevenness, and others. On the other hand, when (Tn−T (μm)) is more than 30 μm, the knurling regions 13 may easily be broken.

The knurling regions 13 are not particularly limited as far as the regions are formed in a band form at both end regions of the polymeric resin film 1 in the width direction thereof. For example, as illustrated in FIG. 2(a), each of the knurling regions 13 may be formed at a position apart from each end of the polymeric resin film 1 by a predetermined distance. Alternatively, as illustrated in FIG. 2(b), the region 13 may be made consistent with each end of the polymeric resin film 1.

In addition, the width W of the knurling regions 13 is preferably from 1 to 5% of the width of the polymeric resin film 1, more preferably from 1 to 2% thereof. When the width is less than 1% thereof, the width of the knurling regions 13 is too small so that the effect of preventing winding shift and the others generated when the film is wound may be declined. When the width is more than 5%, an effective region for exhibiting an optical property becomes narrow so that the production costs may increase.

When concaves 14 made by thermal melting or ablation based on the laser radiation are viewed in plan, the planar shape thereof is circular. For example, even when pushing pressure is applied to the film, this planar shape causes stress to be evenly dispersed from the center of each of the concaves 14 to the vicinity thereof; thus, the film is not easily cracked.

The pattern of the unevennesses in the knurling regions 13 is not particularly limited, and may be appropriately set as the need arises. Specific examples of the pattern include a staggered arrangement pattern and a lattice-form pattern. The unevenness pattern may be even. Alternatively, patterns of unevennesses in individual regions may be different from each other to make the unevenness pattern uneven. Furthermore, the density of the concaves 14 is not particularly limited, and is preferably a density of 10 to 1000 per square centimeter, more preferably a density of 50 to 200 per square centimeter. When the density is less than a density of 10 per square centimeter, the effect of preventing winding shift and the others generated when the film is wound may be declined. When the density is more than a density of 1000 per centimeter, the knurling regions 13 may easily be broken.

The knurling regions 13 are regions worked by the radiation of a laser. The laser light to be used is not particularly limited, and may be, for example, a third harmonic wave or fourth harmonic wave of ArF excimer laser, KrF excimer laser, XeCl excimer laser, YAG excimer laser, a third harmonic wave or fourth harmonic wave of a solid laser of YLF or YVO₄, Ti:S laser, a semiconductor laser, a fiber laser, or carbon dioxide gas laser. Of these lasers, carbon dioxide laser is preferred in the invention from the viewpoint of an improvement in the productivity based on a high power.

The power of the laser radiation ranges preferably from 1 to 20 W, more preferably from 5 to 15 W. By setting the power of the laser radiation to 1 W or more, the radiated amount of the laser is prevented from being insufficient so that the knurling can be sufficiently subjected to the surface of the polymeric resin film 1. On the other hand, by setting the power to 20 W or less, the generation of through holes can be prevented in the polymeric resin film 1 and further thermal effect onto the vicinity of the radiated region can be restrained to prevent the following: the fine work width is made larger and some other phenomenon is caused so that a desired fine pattern cannot be obtained.

In the invention, knurling using a laser is conducted; therefore, by varying the radiating position of the laser onto the polymeric resin film 1 appropriately, the pattern of unevennesses can be changed into various forms as the need arises. Moreover, the unevenness pattern can be formed to have irregular pitch intervals. In this point, the workability can be made better and costs for the production can be made lower as compared with embossing rolls, which need to be exchanged for rolls having a different unevenness pattern in a case where the unevenness pattern of the former rolls is changed.

The light focus diameter of the laser light may be appropriately set dependently on the size of the concaves 14. Accordingly, adjusting the light focus diameter makes it possible for the size of the concaves 14 to be controlled. The light focus diameter is preferably from 100 to 500 μm, more preferably from 200 to 300 μm. When the light focus diameter is less than 100 μm, the pitch intervals of the concaves 14 become too large so that the effect of preventing winding shift and the others generated when the film is wound may be declined. When the light focus diameter is more than 500 μm, the knurling regions 13 may be easily broken.

The number of times of the laser radiation depends on the power thereof; usually, when the laser is once radiated, the concaves 14 are formed. Accordingly, the knurling is conducted by shifting the radiating position of the laser along a predetermined working line while carrying the polymeric resin film 1 at a predetermined line speed. For the scanning of the laser, there is used a method using galvano-scanning or X-Y stage scanning, or a method based on a mask imaging system.

In the invention, bar code data may be printed as the unevenness pattern formed by the knurling. This makes it possible to manage original films. When the line speed or the like of a polymeric resin film is altered in the case of knurling using conventional roll embossment, various complicated set-up conditions, such as the roll temperature, the pushing pressure and the roll material, need to be changed whenever the alternation is made. However, in the case of the knurling using laser radiation in the invention, the knurling can be attained without changing such set-up conditions especially even when the line speed or the like is altered.

The tensile strength of the polymeric resin film 1 before the knurling is 100 MPa or less, preferably from 50 to 90 MPa. The tensile elongation of the polymeric resin film 1 before the knurling is 80% or less, preferably from 1 to 30%.

The polymeric resin film 1 may be an optical film such as a transparent protective film. The transparent protective film is laminated onto at least one of surfaces of a polarizer, and the resultant is used as a polarizing plate. The material which constitutes the transparent protective film may be, for example, a thermoplastic resin excellent in transparency, mechanical strength, thermal stability, water blocking property, isotropy and others. Specific examples of such a thermoplastic resin include cellulose resins such as triacetylcellulose, polyester resin, polyethersulfone resin, polysulfone resin, polycarbonate resin, polyamide resin, polyimide resin, polyolefin resin, (meth)acrylic resin, cyclic polyolefin resin (norbornene based resin), polyarylate resin, polystyrene resin, polyvinyl alcohol resin, and mixtures thereof. Note that the transparent protective film is caused to adhere onto a single side of a polarizer through an adhesive layer. At the other side, a thermosetting resin or ultraviolet curable resin may be used as a transparent protective film, the resin being of a (meth) acrylic, urethane-based, acryl urethane-based, epoxy-based or silicone-based, or the like. One or more arbitrary appropriate additives may be contained in the above-mentioned transparent protective film. Examples of the additives include an ultraviolet absorbent, an antioxidant, a lubricant, a plasticizer, a release agent, a coloring preventive, a flame retardant, a nucleus agent, an antistatic agent, a pigment and a colorant. The content by percentage of the thermoplastic resin in the transparent protective film is preferably from 50 to 100% by weight, more preferably from 50 to 99% by weight, even more preferably from 60 to 98% by weight, in particular preferably from 70 to 97% by weight. When the content by percentage of the thermoplastic resin in the transparent protective film is 50% or less by weight, the film may not sufficiently express a high transparency or others that the thermoplastic resin originally has.

The transparent protective film may be a polymer film described in JP-A-2001-343529 (WO01/37007), for example, a resin composition containing (A) a thermoplastic resin having, in its side chain, a substituted imide group and/or an unsubstituted imide group and (B) a thermoplastic resin having, in its side chain, substituted phenyl and/or unsubstituted phenyl, and a nitrile group. Specific examples thereof include films of a resin composition containing an alternate copolymer composed of isobutylene and N-methylmaleimide, and acrylonitrile/styrene copolymer. The films may each be a film which is a mixed extruded product of the resin composition. These films have a small retardation and a small photoelastic coefficient so that the resins make it possible to overcome unevenness of the polarizing plate based on strain thereof, and other inconveniences. Moreover, the films are excellent in humidification durability since the films have a small moisture permeability.

The thickness of the transparent protective film may be appropriately decided, and is generally from about 1 to 500 μm from the viewpoint of strength, workabilities such as and handleability, thin layer property, and others. In particular, the thickness is preferably from 1 to 300 μm, more preferably from 5 to 200 μm. In a case where the thickness of the transparent protective film is from 5 to 150 μm, the film is particularly preferred.

In a case where transparent protective films are laid on both sides of a polarizer, protective films made of the same polymeric material may be used in the front and back surfaces or protective films made of different polymeric materials or the like may be used therein.

For the transparent protective film of the invention, it is preferred to use at least one selected from cellulose resin, polycarbonate resin, cyclic polyolefin resin, and (meth) acrylic resin.

The cellulose resin is an ester made from cellulose and an aliphatic acid. Specific examples of such a cellulose ester resin include triacetylcellulose, diacetylcellulose, tripropionylcellulose, and dipropionylcellulose. Of these celluloses, triacetylcellulose is particularly preferred. About triacetylcellulose, many products are commercially available, and are advantageous from the viewpoint of availability and costs. Examples of the commercially available products of triacetylcellulose include “UV-50”, “UV-80, “SH-80”, “TD-80U”, “TD-TAC” and “UZ-TAC” (trade names) manufactured by FUJIFILM Corporation, and “KC series” manufactured by Konica Minolta Holdings. In general, these triacetylcelluloses have an in-plane retardation (Re) of about zero while the retardation in the thickness direction (Rth) is up to about 60 nm.

A cellulose resin film having a small retardation in the thickness direction is obtained, for example, by treating the above-mentioned cellulose resin. The method therefor is, for example, a method of causing a substrate film of polyethylene terephthalate, polypropylene, stainless steel or the like onto which a solvent such as cyclopentanone or methyl ethyl ketone is painted to adhere onto an ordinary cellulose based film, heating and drying the workpiece (for example, at 80 to 150° C. for about 3 to 10 minutes), and then peeling the substrate film; or a method of painting a solution wherein norbornene based resin, (meth)acrylic resin or the like is dissolved in a solvent such as cyclopentanone or methyl ethyl ketone onto an ordinary cellulose resin film, heating and drying the workpiece (for example, at 80 to 150° C. for about 3 to 10 minutes), and then peeling the painted film.

In addition, as the cellulose resin film having a small retardation in the thickness direction, an aliphatic acid cellulose based resin film having a controlled fat substitution degree may be used. Triacetylcellulose, which is generally used, has an acetic acid substitution degree of about 2.8. The Rth thereof can be made small by controlling the acetic acid substitution degree into the range of 1.8 to 2.7. Adding a plasticizer such as dibutyl phthalate, p-toluenesulfoneanilide or acetyltriethyl citrate to the aliphatic acid substituted cellulose based resin makes it possible for the Rth to be controlled into a small value. The addition amount of the plasticizer is preferably from 40 parts or less by weight, more preferably from 1 to 20 parts by weight, even more preferably from 1 to 15 parts by weight for 100 parts by weight of the aliphatic acid cellulose based resin.

A specific example of the cyclic polyolefin resin is preferably norbornene based resin. The cyclic olefin based resin is a generic term of resins obtained by polymerizing a cyclic olefin as a polymerizing unit. Examples thereof include resins described in JP-A-1-240517, JP-A-3-14882, JP-A-3-122137, and others. Specific examples thereof include ring-opened (co) copolymers of a cyclic olefin; addition polymers of a cyclic olefin; a cyclic olefin, an α-olefin such as ethylene or propylene, and copolymers thereof (typically, random copolymers); graft polymers wherein these are modified with an unsaturated carboxylic acid or a derivative thereof; and hydrogenated products thereof. A specific example of the cyclic olefin is a norbornene based monomer.

About the cyclic polyolefin resin, various products are commercially available. Specific examples thereof include “ZEONEX”, and “ZEONOR” (trade names) manufactured by Zeon Corporation, “ARTON” (trade name) manufactured by JSR Corp. “TOPAS” (trade name) manufactured by Ticona GmbH, and “APEL” (trade name) manufactured by Mitsui Chemicals, Inc.

Examples of the (meth) acrylic resin include a resin having structural units of an unsaturated carboxylic acid alkyl ester represented by the following general formula (1) and structural units of a glutaric anhydride represented by the following general formula (2):

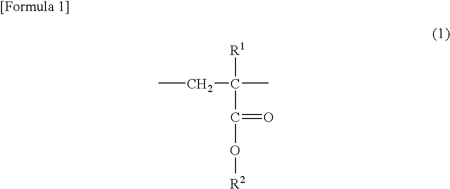

In the general formula (1), R¹ represents a hydrogen atom or an alkyl group having carbon numbers of 1 to 5, and R² represents a hydrogen atom, or an aliphatic or alicyclic hydrocarbon group having carbon numbers of 1 to 6.

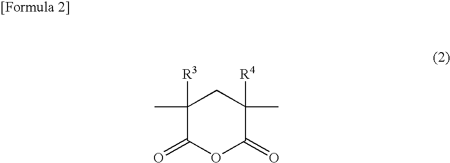

In the general formula (2), R³ and R⁴ may be the same or different, and each represent a hydrogen atom or an alkyl group having 1 to 5 carbon atoms.

Examples of the acrylic resin include resins described in JP-A-2004-70290, JP-A-2004-70296, JP-A-2004-163924, JP-A-2004-292812, JP-A-2005-314534, JP-A-2006-131898, JP-A-2006-206881, JP-A-2006-265532, JP-A-2006-283013, JP-A-2006-299005 and JP-A-2006-335902.

The content by percentage of the structural units each represented by the general formula (1) in the acrylic resin is preferably from 50 to 95% by mol, more preferably from 55 to 90% by mol, even more preferably from 60 to 85% by mol, in particular preferably from 65 to 80% by mol, most preferably from 65 to 75% by mol. When the content by percentage is less than 50% by mol, expressed advantageous effects originating from the structural units represented by the general formula (1), such as a high heat resistance and a high transparency, may not be sufficiently exhibited. When the content by percentage is more than 95% by mol, the resin is brittle so as to be easily cracked so that the resin cannot sufficiently exhibit a high mechanical strength. Thus, the resin may be poor in productivity.

The content by percentage of the structural units each represented by the general formula (2) in the acrylic resin is preferably from 5 to 50% by mol, more preferably from 10 to 45% by mol, even more preferably from 15 to 40% by mol, in particular preferably from 20 to 35% by mol, most preferably from 25 to 35% by mol. When the content by percentage is less than 5% by mol, expressed advantageous effects originating from the structural units represented by the general formula (2), such as high optical characteristics, a high mechanical strength, an excellent adhesion onto a polarizer and thinness, may not be sufficiently exhibited. When the content by percentage is more than 50% by mol, the resin may not sufficiently exhibit, for example, a high heat resistance or a high transparency.

The structural units each represented by the general formula (2) in the acrylic resin are preferably contained in structural units each represented by the following general formula (3):

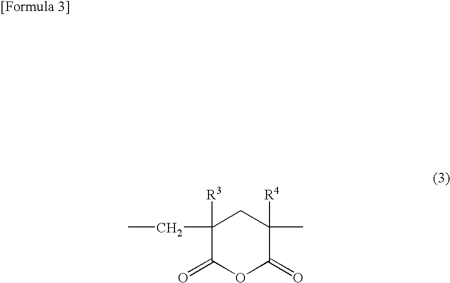

In the general formula (3), R³ and R⁴ may be the same or different, and each represent a hydrogen atom or an alkyl group having carbon numbers of 1 to 5.

In the general formulae (2) and (3), it is preferred that R³ and R⁴ are each a hydrogen atom or a methyl group, and it is more preferred that R³ and R⁴ are each a methyl group.

The acrylic resin having structural units of an unsaturated carboxylic acid alkyl ester represented by the general formula (1) and structural units of a glutaric anhydride represented by the general formula (2) can be basically produced by the following method:

The acrylic resin can be yielded by copolymerizing an unsaturated carboxylic acid alkyl ester monomer corresponding to the structural unit represented by the general formula (1) with an unsaturated carboxylic acid monomer to yield a copolymer (a), heating the copolymer (a) to conduct intermolecular cyclization reaction between the structural units of the unsaturated carboxylic acid alkyl ester monomer and the structural units of the unsaturated carboxylic acid monomer in the copolymer (a), and then introducing the structural units of the glutaric anhydride represented by the general formula (2) into the copolymer.

Examples of the unsaturated carboxylic acid alkyl ester include methyl(meth)acrylate, ethyl(meth)acrylate, n-propyl (meth)acrylate, n-butyl(meth)acrylate, n-butyl(meth)acrylate, n-hexyl(meth)acrylate, cyclohexyl(meth)acrylate, chloromethyl (meth)acrylate, 2-chloroethyl(meth)acrylate, 2-hydroxyethyl (meth)acrylate, 3-hydroxypropyl(meth)acrylate, 2,3,4,5,6-pentahydroxyhexyl(meth)acrylate, and 2,3,4,5-tetrahydroxypentyl(meth)acrylate. These may be used alone or in combination of two or more thereof. Of these, methyl (meth)acrylate is more preferred and methyl methacrylate is particularly preferred since the compound(s) is/are excellent in thermal stability. In other words, it is particularly preferred that in the general formula (1), R¹ is a methyl group and R² is a methyl group.

Examples of the unsaturated carboxylic acid monomer include acrylic acid, methacrylic acid, crotonic acid, α-substituted acrylic acid, and α-substituted methacrylic acid. These may be used alone or in combination of two or more thereof. Of these, acrylic acid and methacrylic acid are particularly preferred since the compounds cause the advantageous effects of the invention to be sufficiently exhibited.

The intermolecular cyclization reaction is preferably intermolecular cyclization reaction based on de-alcohol reaction and/or dehydration. The method for conducting the intermolecular cyclization reaction while conducting heating is not particularly limited, and is preferably a method of passing the copolymer into an extruder having a vent to produce the product, or a method of producing the product in a machine capable of attaining heating and degassing in the flow of nitrogen gas or in vacuum.

Note that in the production of the copolymer (a), about the blend proportion between the monomers, the proportion of the unsaturated carboxylic acid monomer is preferably from 15 to 45% by weight, more preferably from 20 to 40% by weight when the total amount of the blended monomers is defined as 100% by weight. Further, the proportion of the unsaturated carboxylic acid alkyl ester monomer is preferably from 55 to 85% by weight, more preferably from 60 to 80% by weight. In a case where the content by percentage of the unsaturated carboxylic acid monomer is set into the range of 15 to 45% by weight, the content by percentage of the glutaric anhydride represented by the general formula (3) turns into a preferred range of 20 to 40% by weight when the copolymer (a) is heated. Thus, an acrylic resin excellent in heat resistance, colorless transparency, and retention stability can be obtained.

The acrylic resin may contain therein a structural unit other than the structural unit represented by the general formula (1) and the structural unit represented by the general formula (2).

The acrylic resin may contain therein 0 to 10% by weight of structural units that are not involved in the intermolecular cyclization reaction and originate from the unsaturated carboxylic acid monomer. The proportion of the structural units originating from the unsaturated carboxylic acid is more preferably from 0 to 5% by weight, even more preferably from 0 to 1% by weight. When the proportion of the structural units originating from the unsaturated carboxylic acid monomer in the acrylic resin is set to 10% or less by weight, the colorless transparency, the retention stability and the humidity resistance can be maintained.

The acrylic resin in the invention may contain a copolymerizable vinyl-based monomer unit other than the above. Examples of the other vinyl-based monomer unit include acrylonitrile, methacrylonitrile, ethacrylonitrile, allyl glycidyl ether, maleic anhydride, itaconic anhydride, N-methylmaleimide, N-ethylmaleimide, N-cyclohexylmaleimide, acrylamide, methacrylamide, N-methylacrylamide, butoxymethylacrylamide, N-propylmethacrylamide, aminoethyl acrylate, propylaminoethyl acrylate, dimethylaminoethyl methacrylate, ethylaminopropyl methacrylate, cyclohexylaminoethyl methacrylate, N-vinyldiethylamine, N-acetylvinylamine, allylamine, methaallylamine, N-methylallylamine, 2-isopropenyl-oxazoline, 2-vinyl-oxazoline, 2-acroyl-oxazoline, N-phenylmaleimide, phenylaminoethyl methacrylate, styrene, α-methylstyrene, p-glycidylstyrene, p-aminostyrene, and 2-styryl-oxazoline. These may be used alone or in combination of two or more thereof.

About styrene, α-methylstyene or any other styrene based structural unit, out of the above-mentioned other vinyl monomers, the content proportion is preferably from 0 to 1% by weight, more preferably from 0 to 0.1% by weight. When the content concentration of the styrene based structural unit is set into the range of 0 to 1% by weight, a degradation in the retardation and a decrease in the transparency can be prevented.

The weight-average molecular weight of the acrylic resin is preferably from 1000 to 2000000, more preferably from 5000 to 1000000, even more preferably from 10000 to 500000, in particular preferably from 50000 to 500000, most preferably from 60000 to 150000. When the weight-average molecular weight is outside the range, the advantageous effects of the invention may not be sufficiently exhibited.

The Tg (glass transition temperature) of the acrylic resin is preferably 110° C. or higher, more preferably 115° C. or higher, even more preferably 120° C. or higher, in particular preferably 125° C. or higher, most preferably 130° C. or higher. When the Tg is 110° C. or higher, the film easily turns excellent in durability in a case where the film is finally incorporated into a polarizing plate. The upper limit of the Tg of the acrylic resin is not particularly limited, and is preferably 300° C. or lower, more preferably 290° C. or lower, even more preferably 285° C. or lower, in particular preferably 200° C. or lower, most preferably 160° C. or lower from the viewpoint of moldability and others.

As the overall light ray transmittance of a molded product from the acrylic resin by injection molding is higher, the acrylic resin is more preferred. The transmittance is measured by a method in accordance with ASTM-D-1003. The transmittance is preferably 85% or more, more preferably 88% or more, even more preferably 90% or more. When the overall light ray transmittance is less than 85%, the transparency falls so that the resin may not be used for a proper use purpose.

The content by percentage of the acrylic resin in the transparent protective film of the invention is preferably from 50 to 100% by weight, more preferably from 60 to 100% by weight, even more preferably from 70 to 100%, in particular preferably from 80 to 100% by weight. When the content by percentage of the acrylic resin in the transparent protective film of the invention is less than 50% by weight, a high heat resistance and a high transparency that the acrylic resin originally has may not be sufficiently reflected.

The transparent protective film of the invention may contain, for example, acrylic elastomer particles besides the acrylic resin. When the acrylic elastomer particles are dispersed in the transparent protective film, excellent toughness can be obtained for the transparent protective film.

The acrylic elastomer particles preferably contain a rubbery polymer. The rubbery polymer contains, as an essential component, an acrylic component such as ethyl acrylate or butyl acrylate as a starting monomer. Examples of a component that is preferably contained besides the essential component include silicone components such as dimethylsiloxane and phenylmethylsiloxane, styrene components such as styrene and α-styrene methyl, nitrile components such as acrylonitrile and methacrylonitrile, conjugated diene components such as butadiene and isoprene, urethane components, ethylene components, propylene components, and isobutene components. It is preferred to contain at least one selected from acryl components, silicone components, styrene components, nitrile components, and conjugated diene components out of the above-mentioned components. The rubbery polymer may contain a homopolymer from a starting monomer (preferably, each of the above-mentioned components), may contain a copolymer from two or more starting monomers, or may contain both of them. The rubbery polymer is more preferably a rubbery polymer wherein two or more of the above-mentioned components are combined. Examples thereof include a rubbery polymer containing an acrylic component and a silicone component, a rubbery polymer containing an acrylic component and a styrene component, a rubbery polymer containing an acrylic component and a conjugated diene component, and a rubbery polymer containing an acrylic component, a silicone component, and a styrene component.

It is also preferred that the rubbery polymer contains a crosslinking component such as divinylbenzene, allyl acrylate, or butylene glycol diacrylate besides the above-mentioned components.

It is preferred that the particles contain, as the rubbery polymer, a polymer having a combination of an acrylic acid alkyl ester unit and an aromatic vinyl unit. The acrylic acid alkyl ester unit, in particular, butyl acrylate is very effective for improving the toughness; by copolymerizing therewith an aromatic vinyl unit, for example, styrene, the refractive index of the acrylic elastomer particles can be adjusted.

The refractive index difference between the acrylic elastomer particles and the acrylic resin is preferably 0.01 or less since a high transparency can be obtained in the transparent protective film of the invention. The method for setting the refractive index difference between the acrylic elastomer particles and the acrylic resin to 0.01 or less in this way may be any appropriate method. Examples thereof include a method of adjusting the composition ratio between the individual monomer units which constitute the acrylic resin, and a method of adjusting the composition ratio of the rubbery polymer or each of the monomers contained in the acrylic elastomer particles. In particular, by copolymerizing an acrylic acid alkyl ester such as butyl acrylate with an aromatic vinyl monomer such as styrene and adjusting the copolymerization ratio therebetween, acrylic elastomer particles having a small difference in refractive index from the acrylic resin can be obtained.

The average particle diameter of the acrylic elastomer particles is preferably from 70 to 300 nm, more preferably from 100 to 200 nm. When the particle diameter is less than 70 μm, the effect of improving the tenacity may not become sufficient. When the particle diameter is more than 300 nm, the heat resistance may be declined.

The content by percentage of the acrylic elastomer particles in the transparent protective film of the invention is 40% or less by weight, preferably from 7 to 40% by weight, more preferably from 12 to 20% by weight. When the content by percentage is less than 7% by weight, the effect of improving the tenacity may not become sufficient. When the content by percentage is more than 40% by weight, the heat resistance may be declined.

Examples of the resin that can be used together with the acrylic resin in the transparent protective film of the invention include thermoplastic resins such as polyethylene, polypropylene, polyamide, polyphenylenesulfide, polyetheretherketone, polyester, polysulfone, polyphenylene oxide, polyacetal, polyimide and polyetherimide, and thermosetting resins such as phenol-based resin, melamine-based resin, polyester-based resin, silicone-based resin, and epoxy-based resin. These are blended so as not to damage the object of the invention.

Besides, the film may contain one or more additives, examples thereof including an ultraviolet absorbent or antioxidant which is of a hindered phenol-based, benzotriazole-based, benzophenone-based, benzoate-based or cyanoacrylate-based, or the like; a lubricant or plasticizer such as a higher fatty acid, an acid ester-based, an acid amide-based, or a higher alcohol, a release agent such as montanoic acid, a salt thereof, an ester thereof, a half-ester thereof, stearyl alcohol, stearamide or ethylene wax, a coloring preventive such as a phosphite or a hypophosphite, a halogen-based flame retardant, a phosphorus-based or silicone-based halogen-free flame retardant, a nucleus agent, an antistatic agent of an amine-based, sulfonic acid-based or polyether-based, or the like, and a coloring agent such as a pigment. The additive(s) is/are preferably added so as not to deteriorate the transparency of the transparent protective film of the invention in light of characteristics required for an article to which the film is applied. The total content by percentage of the additive(s) in the transparent protective film of the invention is preferably set to 10% or less by weight.

It is allowable to incorporate the acrylic elastomer particles, the other resin(s), and the additive(s) into the starting material(s) for forming the acrylic resin, thereby blending these components when the acrylic resin is produced, or incorporate these components after the acrylic resin is produced.

As the transparent protective film, there is usually used a film having an in-plane retardation of less than 40 nm and a thickness-direction retardation of less than 80 nm. The in-plane retardation Re is represented by Re=(nx−ny)×d, the thickness-direction retardation Rth is represented by Rth=(nx−nz)×d, and the Nz coefficient thereof is represented by Nz=(nx−nz) (nx−ny) wherein nx, ny and nz represent the refractive index of the film in the slow axis direction, that in the fast axis direction, and that in the thickness direction, respectively, d (nm) represents the thickness of the film, and the slow axis direction is defined as the in-plane direction of the film in which the refractive index is maximum. The transparent protective film is preferably not colored as much as possible. The protective film which has a thickness-direction retardation (Rth) of −90 to +75 nm is preferably used. By use of the protective film wherein the thickness-direction retardation (Rth) is from −90 to +75 nm, the coloration (optical coloration) of the polarizing plate resulting from the transparent protective film can be substantially cancelled. The thickness-direction retardation (Rth) is more preferably from −80 nm to +60 nm, in particular preferably from −70 to +45 nm.

In the meantime, as the transparent protective film, there may be used a retardation plate having an in-plane retardation of 40 nm or more and/or a thickness-direction retardation of 80 nm or more. Usually, the in-plane retardation is controlled into the range of 40 to 200 μm, and the thickness-direction retardation is controlled into the range of 80 to 300 μm. In the case of using a retardation plate as the transparent protective film, the retardation plate functions as a transparent protective film also; thus, the retardation plate can be made thin.

The retardation plate may be a birefringence film obtained by subjecting a polymeric material to monoaxial or biaxial drawing treatment, an aligned film of a liquid crystal polymer, a film wherein an aligned film of a liquid crystal polymer is supported on a film, or the like. The thickness of the retardation plate is not particularly limited, and is generally from about 20 to 150 μm.

Examples of the polymeric material include polyvinyl alcohol, polyvinyl butyral, polymethyl vinyl ether, polyhydroxyethyl acrylate, hydroxyethylcellulose, hydroxypropylcellulose, methylcellulose, polycarbonate, polyarylate, polysulfone, polyethylene terephthalate, polyethylene naphthalate, polyethersulfone, polyphenylene sulfide, polyphenylene oxide, polyallylsulfone, polyamide, polyimide, polyolefin, polyvinyl chloride, cellulose resin, and cyclic polyolefin resin (norbornene based resin); and various copolymers or terpolymers, graft copolymers, and blends of these materials. These polymeric polymers are each subjected to drawing treatment or some other treatment, so as to be turned into an aligned product (drawn film).

The liquid crystal polymer is, for example, a polymer that may be of various types, such as a main chain type and a side chain type, wherein a conjugated linear atomic group (mesogen) for giving liquid crystal alignment is introduced into the main chain or a side chain of a polymer. Specific examples of the main chain type liquid crystal polymer include a polyester type liquid crystal polymer having nematic alignment, a discotic polymer, and a cholesteric polymer each having a structure wherein a mesogen group is bonded at a spacer moiety for giving bendability. Specific examples of the side chain type liquid crystal polymer include a polymer having, as a main chain skeleton, polysiloxane, polyacrylate, polymethacrylate or polymalonate and having, as a side chain, mesogen moieties, which are each made of a p-substituted cyclic compound unit for giving nematic alignment, so as to interpose a spacer moiety made of a conjugated atomic group therebetween. These liquid crystal polymers may each be aligned by developing a solution of the liquid crystal polymer onto an alignment treatment surface of, for example, a product wherein a surface of a thin film formed on a glass substrate and made of polyimide, polyvinyl alcohol or the like is subjected to rubbing treatment, a product wherein silicon oxide is obliquely evaporated onto such a surface, or some other product, and then subjecting the resultant to thermal treatment.

The retardation plate may be a retardation plate having an appropriate retardation in accordance with, for example, a purpose of compensation for coloration based on the birefringence of various wavelength plates or liquid crystal layers or for the viewing angle, or some other use purpose. The retardation plate may be a product wherein two or more retardation plates are laminated to control optical properties such as retardation.

The retardation plate satisfying the following relationship is selected in accordance with usage that may be of various types, and then used: nx=ny>nz, nx>ny>nz, nz>ny=nz, nx>nz>ny, nz=nx>ny, nz>nx>ny, or nz>nx=ny. The symbol of ny=nz includes not only a case where ny is completely equal to nz but also a case where ny and nz are substantially equal to each other.

For example, as the retardation plate satisfying nx>ny>nz, it is preferred to use a retardation plate satisfying an in-plane retardation of 40 to 100 nm, a thickness-direction retardation of 100 to 320 nm and an Nz coefficient of 1.8 to 4.5. For example, as the retardation plate satisfying nx>ny=nz (positive A plate), it is preferred to use a retardation plate satisfying an in-plane retardation of 100 to 200 nm. For example, as the retardation plate satisfying nz=nx>ny (negative A plate), it is preferred to use a retardation plate satisfying an in-plane retardation of 100 to 200 nm. For example, as the retardation plate satisfying nx>nz>ny, it is preferred to use a retardation plate satisfying an in-plane retardation of 150 to 300 nm, and an Nz coefficient of more than 0 and less than about 0.7. As described above, it is allowable to use a retardation plate having nx=ny>nz, nz>nx>ny, or nz>nx=ny.

The transparent protective film may be appropriately selected in accordance with a liquid crystal display to which the film is applied. In the case of, for example, a VA (vertical alignment, which may be an MVA or PVA), it is desired that the transparent protective film on at least one side (cell side) of the polarizing plate has a retardation. Specifically, the retardation is desirably as follows: Re=0 to 240 nm, and Rth=0 to 500 nm. When the three-dimensional refractive index is referred to, the following case is desired: nx>ny=nz, nx>ny>nz, nx>nz>ny, or nx=ny>nz (a positive A plate, a biaxis, and a negative C plate). About the VA mode, it is preferred to use a combination of a positive A plate and a negative C plate, or a single biaxial film. When polarizing plates are used on and beneath a liquid crystal cell, the transparent protective films on and beneath the liquid crystal cell may each have a retardation, or either one of the transparent protective films on and beneath the liquid crystal cell may have a retardation.

In the case of, for example, IPS (in-plane switching, which may be FFS), any one of the following cases may be allowable: a case where one of transparent protective films on both sides of the polarizing plate has a retardation, or case where one of the films does not have a retardation. In the case where one of the films does not have a retardation, it is desired that each of the films on and beneath its liquid crystal cell (on the cell side) does not have a retardation. In the case where one of the films has a retardation, the following cases are desired: a case where each of the films on and beneath the liquid crystal cell has a retardation, and a case where either one of the films on and beneath the liquid crystal cell has a retardation (for example, a case where a biaxial film satisfying the relationship of nx>nz>ny is located on the cell and no retardation is exhibited beneath the cell, or a case where a positive A plate is located on the cell and a positive C plate is located beneath the cell). In a case where the transparent protective film has a retardation, the following is desired: Re=−500 to 500 nm, and Rth=−500 to 500 nm. When the three-dimensional refractive index is referred to, the following is desired: nx>ny=nz, nx>nz>ny, nz>nx=ny, or nz>nx>ny (a positive A plate, a biaxis, or a positive C plate).

About the film having a retardation, it is separately caused to adhere onto a transparent protective film having no retardation so that a function as described above can be given thereto.

The transparent protective film may be subjected to surface-modifying treatment before an adhesive is painted thereon. Specific examples of the treatment include corona treatment, plasma treatment, primer treatment, and saponifying treatment.

The surface of the transparent protective film onto which the polarizer is not adhered may be subjected to treatment for forming a hard coating layer, anti-reflection treatment, anti-sticking treatment, or treatment for the purpose of diffusion or anti glare.

The hard coating treatment is a treatment for preventing a surface of a polarizing plate from being injured. The hard coat may be formed by a method of adding, to a surface of the transparent protective film, a hard coat that is made of an appropriate ultraviolet curable resin of an acrylic or silicone-based or the like and is excellent in hardness, lubricity and others, or some other method. The antireflective treatment is a treatment for preventing external light from being reflected on a surface of a polarizing plate. The treatment can be attained by the formation of an antireflective film or the like in accordance with a conventional method. The sticking preventing treatment is a treatment for preventing the film from adhering closely onto an adjacent layer (for example, a diffusing plate on the backlight side).

Anti-glare treatment is carried out to prevent the occurrence of a phenomenon in which external light is reflected off the surface of a polarizing plate to interfere with the visual recognition of light passing through the polarizing plate. Such anti-glare treatment can be achieved by forming fine unevennesses on the surface of the transparent protective film by an appropriate method such as surface roughening (e.g., sandblasting, embossing) or blending of transparent fine particles. Examples of such fine particles to be blended for forming fine unevennesses on the surface of the transparent protective film include transparent fine particles having an average particle size of 0.5 to 20 μm, such as inorganic fine particles of silica, alumina, titania, zirconia, tin oxide, indium oxide, cadmium oxide, antimony oxide, and the like; and organic fine particles of crosslinked or non-crosslinked polymers. These inorganic fine particles may have conductivity. The amount of the fine particles to be used is generally in the range of about 2 to 70 parts by weight, preferably in the range of 5 to 50 parts by weight, with respect to 100 parts by weight of a transparent resin on the surface of which fine unevennesses are to be formed. An anti-glare layer may also serve as a diffusion layer (which has the function of, for example, increasing a viewing angle) for diffusing light passing through a polarizing plate to increase a viewing angle etc.

It is to be noted that the anti-reflection layer, the anti-sticking layer, the diffusion layer, the anti-glare layer, and the like may be provided in the transparent protective film itself. Alternatively, each of the layers may be provided as an optical layer separately from the transparent protective layer.

Adhesion between the transparent protective film and the polarizer is carried out with an adhesive. Examples of such an adhesive include isocyanate-based adhesives, polyvinyl alcohol-based adhesives, gelatin-based adhesives, vinyl-based latexes, and water-based polyesters. The adhesive is generally used as an aqueous adhesive solution having a solid content of 0.5 to 60% by weight. Other examples of the adhesive between the polarizer and the transparent protective film include an ultraviolet curable adhesive, and an electron beam curing adhesive. The electron beam curable adhesive for polarizing plate exhibits an appropriate adhesive property for the above-mentioned various transparent protective film films, and exhibits a good adhesive property, in particular, for acrylic resin, which has not easily been caused to adhere satisfactorily.

As described above, a polarizing plate is manufactured by laminating the transparent protective film and the polarizer together with such an adhesive described above. The adhesive can be applied onto either the transparent protective film or the polarizer or both. After the transparent protective film and the polarizer are laminated together with an adhesive, they are dried to form an adhesive layer comprising a dried coating layer. Lamination between the transparent protective film and the polarizer can be carried out with, for example, a roll laminator. The thickness of the adhesive layer is not particularly limited, but is generally in the range of about 30 to 1000 nm.

The polarizing plate of the invention may be used as a laminated optical film wherein the polarizing plate is laminated onto a different optical layer when the polarizing plate is put into practical use. No specific limitation is placed on the optical layer, and there can be used one optical layer, or two optical layers or more that is used in formation of a liquid crystal display or the like such as a reflection plate, a semipermeation plate, a retardation plate (including ½ or ¼ wavelength plate), and a visual angle compensating film. Especially preferable is a polarizing plate obtained by further laminating a brightness enhancement film on a polarizing plate. In particular, a reflection type polarizing plate or a semipermeation-type polarizing plate in which a reflection plate or a semipermeation reflection plate is further laminated on a polarizing plate, an elliptic polarizing plate or a circular polarizing plate in which a phase difference plate is laminated on a polarizing plate, a wide view angle polarizing plate in which a visual angle compensating film is further laminated on a polarizing plate, or a polarizing plate in which a luminance improving film is further laminated on a polarizing plate is preferable.

A reflection-type polarizing plate is a plate in which a reflection layer is provided on a polarizing plate, is for forming a liquid crystal display device which is a type of reflecting and displaying incident light from a visible side (display side), and has an advantage that building-in of a light source such as back light can be omitted, and a liquid crystal display device is easily thinned. Formation of a reflection-type polarizing plate can be performed by an appropriate format such as a format of providing a reflection layer comprising a metal on one side of a polarizing plate via a transparent protecting layer, if necessary.

A semi-permeation polarizing plate can be obtained by adopting a semi-permeation type reflection layer such as a half mirror which reflects light on a reflection layer and permeates light in the aforementioned plate. The semi-permeation polarizing plate is usually provided on a back side of a liquid crystal cell, and such a type of a liquid crystal display device can be formed that, when a liquid crystal display device is used in the relatively light atmosphere, incident light from a visible side (display side) is reflected to display an image and, in the relatively dark atmosphere, an image is displayed using a built-in light source such as back light built in a back side of a semi-permeation polarizing plate. That is, the semi-permeation polarizing plate is useful for forming such a type of a liquid crystal display device that energy which is used in a light source such as back light can be saved, and the device can be used using a built-in light source also under the relatively dark atmosphere.

An elliptic polarizing plate or a circular plate in which a phase difference plate is further laminated on a polarizing plate will be explained. When a linearly polarized light is changed to elliptically polarized light or a circularly polarized light, or elliptically polarized light or circularly polarized light is changed to linearly polarized light, or a polarization direction of linearly polarized light is changed, a phase difference plate is used. In particular, as a phase difference plate for changing linearly polarized light to circularly polarized light, or changing circularly polarized light to linearly polarized light, a so-called ¼ wavelength plate (also referred to as λ/4 plate) is used. A ½ wavelength plate (also referred to as λ/2 plate) is usually used when a polarization direction of linearly polarized light is changed.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflective type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, polyvinyl alcohols, polystyrenes, poly methyl methacrylates, polypropylene; polyallylates and polyamides; oriented films comprising liquid crystal materials, such as liquid crystal polymer; and films on which an alignment layer of a liquid crystal material is supported may be mentioned. A retardation plate may be a retardation plate that has a proper phase difference according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The aforementioned elliptic polarizing plate or reflection-type elliptic polarizing plate is such that an appropriate combination of a polarizing plate or a reflection-type polarizing plate and a phase difference plate is laminated. Such the elliptic polarization plate can be formed by successively and separately laminating a (reflection-type) polarizing plate and a phase difference plate in a process for manufacturing a liquid crystal display device so that a combination of the (reflection-type) polarizing plate and the phase difference plate is obtained, and an optical member such as an elliptic polarizing plate which has been formed in advance as described above has an advantage that it is excellent in stability of quality and laminating workability, and an efficiency of manufacturing a liquid crystal display device can be improved.

A visual angle compensating film is a film for extending a view angle so that an image is seen relatively clearly even when a screen of a liquid crystal display device is seen not from a direction vertical to the screen but from a slightly slant direction. Such the visual angle compensating phase difference plate is such that an orientation layer of a liquid crystal polymer is supported on a phase difference plate, an oriented film such as a liquid crystal polymer, or a transparent substrate. In a normal phase difference plate, a polymer film having birefringence which has been monoaxially stretched in its surface direction is used, while in a phase difference plate used as a visual angle compensating film, a bidirectional stretched film such as a polymer film having birefringence which has been biaxially stretched in a surface direction, a polymer having birefringence which has been monoaxially stretched in a surface direction, is also stretched, and also stretched in a thickness direction, and has a controlled refractive index in a thickness direction, and a slantly oriented film is used. Examples of the slantly oriented film include a film obtained by adhering a thermally shrinking film to a polymer film, and subjecting the polymer film to stretching treatment or/and shrinking treatment under action of a shrinking force due to heating, and a film in which a liquid crystal polymer is slantly oriented. As a raw material polymer for a phase difference plate, the same polymer as that explained for the previous phase difference plate is used, and an appropriate polymer for the purpose of preventing coloration due to change in a visual confirmation angle based on a phase difference due to a liquid crystal cell, or extending a view angle for better visual confirmation can be used.

In addition, from a viewpoint of accomplishment of a wide view angle for better visual confirmation, an optical compensating phase difference plate in which an optically anisotropic layer comprising an oriented layer of a liquid crystal polymer, in particular, a slantly oriented layer of a discotic liquid crystal polymer is supported by a triacetylcellulose film can be preferably used.

A polarizing plate in which a polarizing plate and a luminance improving film are laminated is usually used by provision on a back side of a liquid crystal cell. The luminance improving film exhibits such the property that, when natural light is introduced by back light of a liquid crystal display device, or reflection from a back side, linearly polarized light having a prescribed polarization axis or circularly polarized light in a prescribed direction is reflected, and other light is permeated. In a polarizing plate in which the luminance improving film is laminated on a polarizing plate, light from a light source such as back light is introduced to obtain permeated light in the prescribed polarized state and, at the same time, light other than the aforementioned prescribed polarized state is reflected without permeation. Light reflected on a surface of this luminance improving film is inverted via a reflection layer provided on its rear side to introduce into the luminance improving film again, a part or all of this is permeated as light in the prescribed polarized state to increase an amount of light permeating through the luminance improving film and, at the same time, polarized light which is absorbed in a polarizer with difficulty is supplied to increase an amount of light which can be utilized in a liquid crystal display image display, thereby, a luminance can be improved. That is, when light is introduced through a polarizer from a back side of a liquid crystal cell by back light without using the luminance improving film, most of light having a polarization direction which is not consistent with a polarization axis of a polarizer is absorbed in a polarizer, and is not permeated through a polarizer.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

The polarizing plate may be made of a product wherein a polarizing plate is laminated onto two or more optical layers, similarly to the above-mentioned polarized light separation type polarizing plate. Accordingly, the polarizing plate may be a reflective type elliptically polarizing plate, or a semi-transmissive type elliptically polarizing plate, wherein the above-mentioned reflective type polarizing plate or semi-transmissive type polarizing plate is combined with a retardation plate.

Although an optical film having the optical layers laminated on the polarizing plate can be formed in the manufacturing process of, for example, liquid crystal displays by a method in which the optical layers are laminated one by one, a method in which the previously laminated optical layers are laminated on the polarizing plate is advantageous in that it can improve the quality stability of the optical film and the efficiency of assembly work of liquid crystal displays. Laminating is carried out by using an appropriate adhesion means such as a pressure-sensitive adhesive layer. In adhesion of the polarizing plate and other optical films, their optical axes may be arranged so that they have appropriate arrangement angles according to desired retardation characteristics etc.

On the optical film such as the polarizing plate mentioned above, an adhesive layer may be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to the optical device or the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on each layer as a layer in which pressure sensitive adhesives with different composition or different kind etc. are laminated together. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

### EXAMPLES

Preferred examples of the invention are illustratively described in detail below. Unless otherwise stated, the materials, contents and so on as shown in the examples are not intended to limit the scope of the invention in any way and are intended for illustration purposes only.

### Examples 1 to 5

As each of polymeric resin films, a polymethyl methacrylate film (PMMA) having a width of 1300 mm was used, and a laser was radiated onto both end regions thereof in the width direction under conditions described below to conduct knurling. The results are shown in Table 1 described below. In each of the examples, the thickness and the knurling height of the PMMA film were set as shown in Table 1.

### [Laser Radiating Machine]

The used laser radiating machine was as follows:

Laser ray source: carbon dioxide gas laser

Laser wavelength: 9.3 μm

Highest power: 20 W

### [Laser Ray Radiating Conditions]

Laser power: 10 W

Spot diameter: 300 μm in diameter

Line speed: 40 m/min.

Print width (knurling regions): 13 mm in width from each end of the film

Print density (density of concaves): a density of 100 per cm²

Knurling surface: only one of the film surfaces

Print (concave) shape: circular

### Examples 6 to 10

In the present examples, knurling was conducted in the same way as in Examples 1 to 5, respectively, except that the knurling height was changed to 10 μm. The results are shown in Table 1.

### Examples 11 to 15

In the present examples, knurling was conducted in the same way as in Examples 1 to 5, respectively, except that the knurling height was changed to 5 μm. The results are shown in Table 1.

### Comparative Examples 1 to 5

In each of the present comparative examples, the same manner as in Example 1 was conducted except that knurling based on roll emboss was conducted instead of the laser radiation. The results are shown in Table 2. In each of the Comparative Examples, the thickness and the knurling height of the PMMA film were set as shown in Table 2. Conditions for the roll emboss were as follows:

Line speed: 40 m/min.

Knurling roll: iron roll

Backup roll: iron roll

Roll temperature: 180° C.

Print width (knurling regions): 13 mm in width from each end of the film

Density of unevennesses: a density of about 100 per cm²

Line pressure: 20 kgf/cm

Engraving roll (dielectric heating roll) shape: lozenge

### Comparative Examples 6 to 10

In the present comparative examples, knurling was conducted in the same way as in Comparative Examples 1 to 5, respectively, except that the knurling height was changed to 10 μm. The results are shown in Table 2.

### Comparative Examples 11 to 15

In the present comparative examples, knurling was conducted in the same way as in Comparative Examples 1 to 5, respectively, except that the knurling height was changed to 5 μm. The results are shown in Table 2.

### Examples 16 to 20

In the present examples, knurling was conducted in the same way as in Examples 1 to 5, respectively, except that a norbornene based film (trade name: ZEONOR (article number: ZF14) manufactured by Zeon Corporation) was used instead of the PMMM film. The results are shown in Table 3.

### Examples 21 to 25

In the present examples, knurling was conducted in the same way as in Examples 16 to 20, respectively, except that the knurling height was changed to 10 μm. The results are shown in Table 3.

### Examples 26 to 30

In the present examples, knurling was conducted in the same way as in Examples 26 to 30, respectively, except that the knurling height was changed to 5 μm. The results are shown in Table 3.

### Comparative Examples 16 to 20

In the present comparative examples, knurling was conducted in the same way as in Comparative Examples 1 to 5, respectively, except that a ZEONOR film (trade name: ZEONOR (article number: ZF14) manufactured by Zeon Corporation) was used instead of the PMMM film. The results are shown in Table 4.

### Comparative Examples 21 to 25

In the present comparative examples, knurling was conducted in the same way as in Comparative Examples 16 to 20, respectively, except that the knurling height was changed to 10 μm. The results are shown in Table 4.

### Comparative Examples 26 to 30

In the present comparative examples, knurling were conducted in the same way as in Comparative Examples 16 to 20, respectively, except that the knurling height was changed to 5 μm. The results are shown in Table 4.

### <Breakability>

First, the breakability was checked at the time of the knurling based on the laser radiation or the roll embossment. A case where a crack, a chap, a notch or the like was generated in the knurling regions during the knurling was judged as breakage, and is represented by x. A case where the film was suddenly broken is represented by Δ, and a case where the film was not broken at all is represented by ◯.

A mandrel (diameter: 2 mm) was used to bent each of the films after it was knurling, and then a bending resistance test (JIS K 5600-5-1) was made in the knurling regions. A case where a crack, a chap, a notch or the like was generated in the knurling regions was judged as breakage, and is represented by x. A case where the film was suddenly broken is represented by Δ, and a case where the film was not broken at all is represented by ◯.

### <Tensile Strength and Tensile Elongation>

The tensile strength (MPa) and the tensile elongation (%) were measured in accordance with ASTM D638. The results are shown in Table 5 described below.

TABLE 1

| | METHOD OF | FILM | KNURLING | DURING | AFTER |
|---|---|---|---|---|---|
| | KNURLING | THICKNESS (μm) | HEIGHT | KNURLING | KNURLING |
| Example 1 | laser | 30 | 20 | ∘ | x |
| Example 2 | radiation | 40 | 20 | ∘ | ∘ |
| Example 3 | | 50 | 20 | ∘ | ∘ |
| Example 4 | | 60 | 20 | ∘ | ∘ |
| Example 5 | | 100 | 20 | ∘ | ∘ |
| Example 6 | | 30 | 10 | ∘ | x |
| Example 7 | | 40 | 10 | ∘ | ∘ |
| Example 8 | | 50 | 10 | ∘ | ∘ |
| Example 9 | | 60 | 10 | ∘ | ∘ |
| Example 10 | | 100 | 10 | ∘ | ∘ |
| Example 11 | | 30 | 5 | ∘ | ∘ |
| Example 12 | | 40 | 5 | ∘ | ∘ |
| Example 13 | | 50 | 5 | ∘ | ∘ |
| Example 14 | | 60 | 5 | ∘ | ∘ |
| Example 15 | | 100 | 5 | ∘ | ∘ |

TABLE 2

| | METHOD OF | FILM | KNURLING | DURING | AFTER |
|---|---|---|---|---|---|
| | KNURLING | THICKNESS (μm) | HEIGHT | KNURLING | KNURLING |
| Comparative | roll | 30 | 20 | x | x |
| Example 1 | emboss | | | | |
| Comparative | | 40 | 20 | x | x |
| Example 2 | | | | | |
| Comparative | | 50 | 20 | x | x |
| Example 3 | | | | | |
| Comparative | | 60 | 20 | ∘ | ∘ |
| Example 4 | | | | | |
| Comparative | | 100 | 20 | ∘ | ∘ |
| Example 5 | | | | | |
| Comparative | | 30 | 10 | x | x |
| Example 6 | | | | | |
| Comparative | | 40 | 10 | x | x |
| Example 7 | | | | | |
| Comparative | | 50 | 10 | Δ | ∘ |
| Example 8 | | | | | |
| Comparative | | 60 | 10 | ∘ | ∘ |
| Example 9 | | | | | |
| Comparative | | 100 | 10 | ∘ | ∘ |
| Example 10 | | | | | |
| Comparative | | 30 | 5 | x | x |
| Example 11 | | | | | |
| Comparative | | 40 | 5 | Δ | ∘ |
| Example 12 | | | | | |
| Comparative | | 50 | 5 | ∘ | ∘ |
| Example 13 | | | | | |
| Comparative | | 60 | 5 | ∘ | ∘ |
| Example 14 | | | | | |
| Comparative | | 100 | 5 | ∘ | ∘ |
| Example 15 | | | | | |

TABLE 3

| | METHOD OF | FILM | KNURLING | DURING | AFTER |
|---|---|---|---|---|---|
| | KNURLING | THICKNESS (μm) | HEIGHT | KNURLING | KNURLING |
| Example 16 | laser | 30 | 20 | ∘ | Δ |
| Example 17 | radiation | 40 | 20 | ∘ | ∘ |
| Example 18 | | 50 | 20 | ∘ | ∘ |
| Example 19 | | 60 | 20 | ∘ | ∘ |
| Example 20 | | 100 | 20 | ∘ | ∘ |
| Example 21 | | 30 | 10 | ∘ | ∘ |
| Example 22 | | 40 | 10 | ∘ | ∘ |
| Example 23 | | 50 | 10 | ∘ | ∘ |
| Example 24 | | 60 | 10 | ∘ | ∘ |
| Example 25 | | 100 | 10 | ∘ | ∘ |
| Example 26 | | 30 | 5 | ∘ | ∘ |
| Example 27 | | 40 | 5 | ∘ | ∘ |
| Example 28 | | 50 | 5 | ∘ | ∘ |
| Example 29 | | 60 | 5 | ∘ | ∘ |
| Example 30 | | 100 | 5 | ∘ | ∘ |

TABLE 4

| | METHOD OF | FILM | KNURLING | DURING | AFTER |
|---|---|---|---|---|---|
| | KNURLING | THICKNESS (μm) | HEIGHT | KNURLING | KNURLING |
| Comparative | roll | 30 | 20 | x | x |
| Example 16 | emboss | | | | |
| Comparative | | 40 | 20 | x | x |
| Example 17 | | | | | |
| Comparative | | 50 | 20 | Δ | Δ |
| Example 18 | | | | | |
| Comparative | | 60 | 20 | ∘ | ∘ |
| Example 19 | | | | | |
| Comparative | | 100 | 20 | ∘ | ∘ |
| Example 20 | | | | | |
| Comparative | | 30 | 10 | x | x |
| Example 21 | | | | | |
| Comparative | | 40 | 10 | Δ | Δ |
| Example 22 | | | | | |
| Comparative | | 50 | 10 | Δ | ∘ |
| Example 23 | | | | | |
| Comparative | | 60 | 10 | ∘ | ∘ |
| Example 24 | | | | | |
| Comparative | | 100 | 10 | ∘ | ∘ |
| Example 25 | | | | | |
| Comparative | | 30 | 5 | Δ | Δ |
| Example 26 | | | | | |
| Comparative | | 40 | 5 | Δ | ∘ |
| Example 27 | | | | | |
| Comparative | | 50 | 5 | ∘ | ∘ |
| Example 28 | | | | | |
| Comparative | | 60 | 5 | ∘ | ∘ |
| Example 29 | | | | | |
| Comparative | | 100 | 5 | ∘ | ∘ |
| Example 30 | | | | | |

TABLE 5

| | TENSILE STRENGTH | TENSILE ELONGATION |
|---|---|---|
| Kind of film | (MPa) | (%) |
| PMMA film | 75 | 2.9 |
| norbornene | 75 | 10 |
| based film | | |

### (Results)

As understood from Tables 1 and 3, in each of the Examples, it was verified that a crack, a chap, a notch or the like was not generated at all in the knurling regions during the knurling. In a case where the film thickness was 40 μm or more, the knurling regions were not broken even when the bending resistance test was made after the knurling.

On the other hand, as understood from Tables 2 and 4, in each of the Comparative Examples, it was found out that the film was broken during the knurling or in the bending resistance test after the knurling. The film was broken, in particular, when the film thickness was small.

1. A polymeric resin film, wherein about at least one of its surfaces, both end regions thereof in the width direction of the film are subjected to knurling by radiation of a laser.

2. The film according to claim 1, wherein when the average thickness of the region not subjected to the knurling is represented by T (μm) and the average thickness of both the end regions subjected to the knurling is represented by Tn (μm),
T (μm) ranges from 20 to 70 μm and Tn−T ranges from 3 to 30 μm.

3. The film according to claim 1, which has a tensile strength of 100 MPa or less and a tensile elongation of 80% or less.

4. The film according to claim 1, wherein the regions subjected to the knurling are located in a band form in the longer direction in both the end regions of the film, and the width thereof ranges from 1 to 5% of the width of the film.

5. The film according to claim 1, wherein concaves in the regions subjected to the knurling are formed at a density ranging from a density of 10 to 1000 per square centimeter.

6. The film according to claim 1, wherein the planar shape of the concaves in the regions subjected to the knurling is circular.

7. The film according to claim 1, wherein the polymeric resin film is an optical film.

8. The film according to claim 7, wherein the optical film is a transparent protective film.

9. The film according to claim 8, wherein the transparent protective film is a norbornene based film or an acrylic film.

10. A polarizing plate wherein a film as recited in claim 1 is set on at least one of surfaces of a polarizer.

11. A process for producing a film, wherein about at least one of surfaces of a polymeric resin film, a laser is radiated onto both end regions thereof in the width direction of the film under predetermined conditions, thereby subjecting both the end regions to knurling.

12. The process for producing a film according to claim 11, wherein the radiation of the laser is performed so as not to penetrate the film in such a manner that the power thereof is set into the range of 1 to 20 W.
